(19) United States
(12) Patent Application Publication
(10) Pub. No.: US 2006/0195845 A1
(43) Pub. Date: Aug. 31, 2006

(54) System and method for scheduling executables

(76) Inventor: Scott A. Rhine, Frisco, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/067,852

(22) Filed: Feb. 28, 2005

(51) Int. Cl. G06F 9/46

(52) U.S. Cl. 718/102

(57) ABSTRACT

In one embodiment, a computer system comprises a plurality of processors, a plurality of groups of executables, wherein a respective share parameter is defined for each group that represents an amount of processor resources to support executables of the group, a software routine that generates a plurality of weights using the share parameters and generates a distribution of the weights across the plurality of processors, wherein the distribution defines a subset of processors for each group and a proportion of each processor within the subset for scheduling executables of the group, and a scheduling software routine for scheduling each executable of the plurality of groups on a specific processor of the plurality of processors during a scheduling interval according to the distribution.

### TECHNICAL FIELD

The present application is generally related to scheduling access to computer resources.

### BACKGROUND

Many enterprises have experienced a dramatic increase in the number of computers and applications employed within their organizations. When a business group in an enterprise deploys a new application, it is possible to add one or more dedicated server platforms to host the new application. This type of environment is sometimes referred to as “one-app-per-box.” As more business processes have become digitized, a “one-app-per-box” environment leads to an inordinate number of server platforms. As a result, administration costs of the server platforms increase significantly. Moreover, the percentage of time that the server platform resources are actually used (the utilization rate) can be quite low. To address these issues, many enterprises have consolidated multiple applications onto common server platforms to reduce the number of platforms and increase the system utilization rates. When such consolidation occurs, some functionality is typically provided to determine when applications and other executables obtain access to processor resources. Such functionality is typically referred to as “scheduling.”

A number of scheduling algorithms of varying complexity exist. Perhaps, the most simple scheduling is the first-come, first-served algorithm. Priority-based algorithms assign priorities to processes and processes having the highest priority are selected to run at appropriate times. Pre-emptive scheduling algorithms may be used to remove a lower priority process from a processor when a higher priority process becomes ready to run. Round robin scheduling algorithms allow a process to execute until expiration of a time interval and, then, another executable is selected to run on the respective processor. Additionally, fair share schedulers define percents or shares and provide processes an opportunity to access processor resources in proportion to the defined shares.

### SUMMARY

In one embodiment, a computer system comprises a plurality of processors, a plurality of groups of executables, wherein a respective share parameter is defined for each group that represents an amount of processor resources to support executables of the group, a software routine that generates a plurality of weights using the share parameters and generates a distribution of the weights across the plurality of processors, wherein the distribution defines a subset of processors for each group and a proportion of each processor within the subset for scheduling executables of the group, and a scheduling software routine for scheduling each executable of the plurality of groups on a specific processor of the plurality of processors during a scheduling interval according to the distribution.

In another embodiment, a method comprises defining a plurality of share parameters that represent an amount of processor resources for scheduling executables of a plurality of groups, generating a plurality of weights according to an integer partition problem (IPP) using the plurality of share parameters, determining a distribution of the weights across a plurality of processors using an IPP algorithm, and scheduling executables of groups on the plurality of processors using the distribution.

In another embodiment, a computer system comprises a plurality of resource devices, a plurality of groups of executables, wherein a respective share parameter is defined for each group that represents an amount of access to the plurality of resource devices to support executables of the group, a software routine that generates a plurality of weights using the share parameters and generates a distribution of the weights across the plurality of resource devices, wherein the distribution defines a subset of resource devices for each group and a proportion of each resource device within the subset for scheduling executables of the group, and a scheduling software routine for scheduling each executable of the plurality of groups on a specific resource device of the plurality of resource devices according to the distribution.

In another embodiment, a computer system comprises means for generating a distribution of weights across a plurality of resource devices of the computer system using an integer partition problem (IPP) algorithm, wherein the weights are generated from a plurality of share parameters that each represent an amount of access to the plurality of resource devices to be provided to a respective group of executables, wherein the distribution defines a subset of resource devices for each group and a proportion of each resource device within the subset for scheduling executables of the group, and means for scheduling each executable of the groups on a resource device according to the distribution.

### BRIEF DESCRIPTION OF THE DRAWINGS

FIG. 1 depicts a system that schedules virtual processors on a plurality of a physical processors according to one representative embodiment.

FIG. 2 depicts a flowchart involving an IPP algorithm that generates one or several distributions that map each group of executables onto a set of CPUs to support scheduling operations according to one representative embodiment.

FIG. 3 depicts a flowchart for scheduling individual jobs on specific physical CPUs according to one representative embodiment.

FIG. 4 depicts a distribution defining a mapping between groups of executables and a plurality of processors.

### DETAILED DESCRIPTION

Some representative embodiments perform scheduling operations for share-based workload groups using integer partition problem (IPP) algorithms. Each group is given a parameter value representing a “share” of system resources assigned to that group. A software module maps each group to one or several processors using an IPP algorithm. Specifically, the group shares are separated into “weights” and the weights are distributed to processor (“bins”) such that the weights associated with each processor are approximately equal.

The separation of the shares into weights may account for multiple “virtual processors” used to support some of the workloads. For example, if a group is assigned four virtual CPUs with each virtual CPU having approximately 75 percent capacity of a physical CPU, the group would generate four separate weights of 75 each. The weights do not exactly correspond to percentages of resources, because each CPU may be scheduled with more or less than 100 shares. The actual scheduling percentage for a particular CPU is determined using the total weight of all jobs currently running on the CPU.

Also, separation of the share parameter of a default or lowest priority group into multiple weights may occur on a variable basis to improve the probability of achieving an optimal distribution of weights across the processors. This default group may be used to hold all resource requests that do not have a specific weight or priority. In one implementation, all members of the default group equally divide the resources not already assigned to other groups.

The distribution generated by the IPP algorithm provides a list of physical CPUs for each group and the proportions of those CPUs that the respective group will receive in a scheduling interval. Additionally, the amount of processor time that each job receives is tracked using job scheduling parameters. Jobs accumulating more processor ticks in a time sampling interval have their parameters reduced. Jobs accumulating less than the average processor ticks have their parameters incremented. Upon each new scheduling interval, jobs having the highest parameter values are selected for the available physical CPUs that will provide more processor ticks to these jobs (i.e., the CPU(s) with the lowest total scheduling weight). Also, if the scheduling weights of two CPUs are equal, the lowest historical usage is employed to select the better CPU.

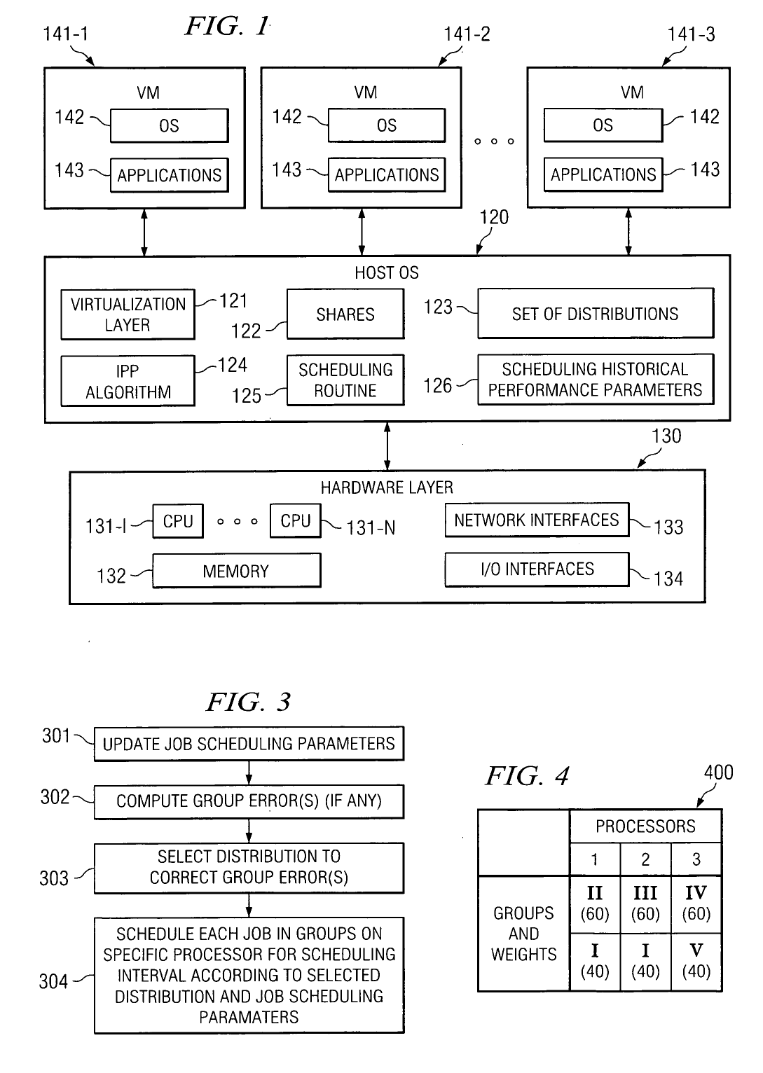

Referring now to the drawings, FIG. 1 depicts system 100 according to one representative embodiment. System 100 includes host operating system 120 that controls low-level access to hardware layer 130 of the platform. In one embodiment, host operating system 120 includes virtualization layer 121 within its kernel as an example. Virtualization layer 121 creates software constructs (logical devices) that correspond to the physical resources of hardware layer 130. Hardware layer 130 may include any number of physical resources such as CPUs 131-1 through 131-N, memory 132, network interfaces 133 input/output (I/O) interfaces 134, and/or the like.

In one embodiment, virtual resources (e.g., one or several virtual CPUs, virtual memory, virtual network interface card, virtual I/O interface, and/or the like) are assigned to each virtual machine 141. The number of virtual CPUs may exceed the number of physical CPUs 131. Each virtual machine 141 is executed as a process on top of operating system 120 in accordance with its assigned virtual resources. CPU virtualization may occur in such a manner to cause each virtual machine 141 to appear to run on its own CPU or set of CPUs. The CPU virtualization may be implemented by providing a set of registers, translation lookaside buffers, and other control structures for each virtual CPU. Accordingly, each virtual machine 141 is isolated from other virtual machines 141. Additionally, each virtual machine 141 is used to execute a respective guest operating system 142. The virtual resources assigned to the virtual machine 141 appear to the guest operating system 142 as the hardware resources of a physical server. Guest operating system 142 may, in turn, be used to execute one or several applications 143.

Scheduling routine 125 determines which executable threads associated with virtual machines 141 are run on respective processors 131. The executable threads are given the opportunity to execute on respective processors 131 a guaranteed proportion of the time. The proportions are defined, in part, for a given scheduling interval according to groups of executable threads. For example, each virtual machine 141 may be assigned to a group and shares 122 are defined for the various groups. Each share parameter represents a minimum amount of processor “ticks” that the virtual machines 141 of the respective group should receive on average.

The shares, combined with the current demand of a virtual machine group, are translated into weighted resource requests. IPP algorithm 124 uses these weights to map each group to a set of physical CPUs. The mapping is referred to as a distribution (stored in element 123) and, for each group, the mapping contains a list of CPUs, how many threads run on each, and for what proportion of the time. The distribution generated by IPP algorithm 124 causes the total weight serviced by each CPU to be as uniform as possible.

Within a given scheduling interval, scheduling routine 125 determines which executable within each group runs on each processor 131 using a respective distribution 123 and scheduling parameters 126. As previously noted, the selected distribution 123 defines the physical CPUs available for each group. Using scheduling parameters 126, scheduling routine 125 determines which specific threads from a respective group will run on which CPUs in that list for this interval. Scheduling parameters 126 are indicative of the historical receipt of processor ticks received by the various executables. Executables having the highest parameter values are selected for the best available physical CPUs. Upon completion of a scheduling interval, executables accumulating less than the average processor ticks have their parameters incremented and executables accumulating more than the average have their parameters reduced.

Although mapping and scheduling associated with virtual processors have been discussed, other representative embodiments may be used to schedule any type of executable on any appropriate multi-processor computer system. Additionally, the mapping and scheduling may occur for any type of time-sliced resource on a computer (e.g., networking cards, disk IO channels, cryptographic devices, and/or the like).

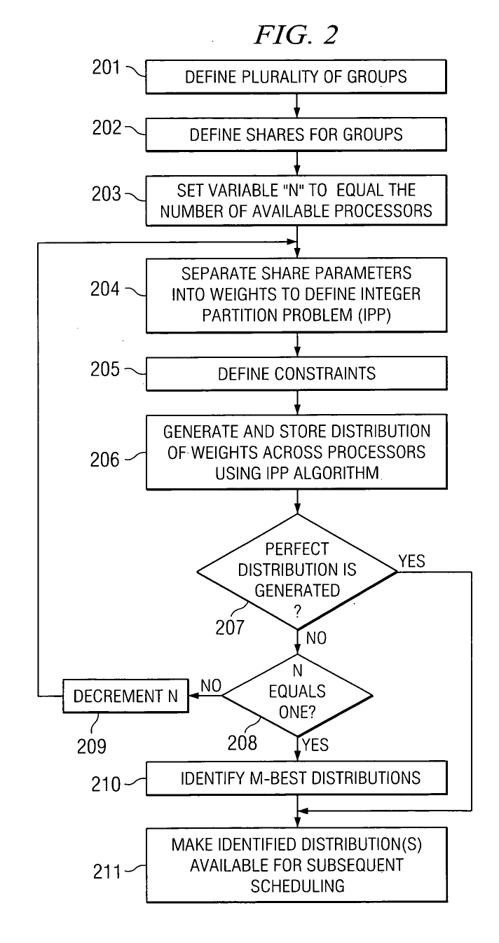

FIG. 2 depicts a flowchart for generating a mapping of groups of software jobs to processors according to one representative embodiment. FIG. 2 is implemented using software code or instructions retrieved from a suitable computer readable medium. In step 201, a plurality of groups are defined to support a plurality of jobs. In one embodiment, each job is supported by a respective virtual machine. Each virtual machine comprises one or several virtual processors. In step 202, shares are defined for the groups. The shares define the amount of processor resources that the respective groups will have an opportunity to receive on average. In one embodiment, the shares encode processor “ticks” where 100 ticks represents the entire capacity of a single physical processor within one second of time. In some embodiments, a lowest priority or default group is defined that receives all of the ticks that are not explicitly assigned to other groups. For example, suppose a computer system supports six jobs (A, B, C, D, and E) and has two processors (200 total shares are available). Job A is assigned to a “high” priority group and receives 80 shares. Job B is assigned to a “medium” priority group and receives 45 shares. Jobs C, D, and E are assigned to the default group and the default group is assigned the remaining 75 shares with each group receiving approximately 25 shares on average. By assigning executables to groups, the combinatorial complexity of the integer partition problem is appreciably reduced.

In step 203, a variable (N) is set to equal the minimum of (i) the number of physical processors that are available in the computer system for scheduling purposes and (ii) the number of active jobs in the default group.

In step 204, the share parameter for the groups are separated into distinct weights. In some embodiments, the share parameter for the default group is divided into N distinct equal weights (or approximately equal weights to account for rounding errors). Using the prior two processor example, upon the first iteration, the share parameter (75) for the default group may be divided into a first weight of 37 and a second weight of 38. In some embodiments, the shares of the groups are additionally separated into distinct weights to account for multi-threaded jobs. For example, suppose job A is implemented using a virtual machine having two virtual processors. The 80 shares of the high priority group may be divided into two weights of 40 to support the threads of the two virtual processors. If a group (other than the default group) does not contain multi-threaded jobs, a single weight is generated for the group that equals its share parameter.

In step 205, constraints are defined to limit the distribution of weights among processors. The constraints can be generated automatically according to a set of predefined rules or conditions. For example, if multiple resource requests weights are generated for a multi-threaded job, a constraint is defined to prevent those weights from being assigned to the same processor. Also, constraints can be defined manually for specific systems, e.g., to separate redundant software modules used for high availability applications.

In step 206, an IPP algorithm is used generate a distribution of the weights across a list of processors in a manner that achieves the optimal balance of the weights across the processors. The generation distribution is temporarily stored for further analysis (see step 210). Known IPP algorithms can be employed such as the “greedy” method in which the “bin” having the lowest total previously assigned weights is assigned the highest remaining weight until all weights have been assigned. Alternatively, the “difference” method may be employed in which assignment occurs by placing largest numbers in different subsets and inserting their difference as a new number. After all of the numbers are assigned in this manner, the distribution of the original weights is determined by backward recursion. Details regarding the implementation of IPP algorithms are available from a number of sources. For example, an overview of IPP algorithms is given in the article “On the Integer Partitioning Problem: Examples, Intuition and Beyond,” by Haikun Zhu, Dec. 14, 2002, which is incorporated herein by reference.

According to some embodiments, solutions are first computed using the rapid greedy method. If the solution is not perfect, an N-dimensional difference method is employed and the solution with the highest accuracy is selected. The distribution of weights into the processor bins will determine the CPU choices available to each group. The weight associated with a particular job divided by the total weight on a CPU determines the portion of that CPU that will ultimately be provided. It should be noted that an explicit mapping of specific threads to CPUs has not occurred at this stage. Instead, only groups of threads have been mapped to a set of CPUs. Additionally, after an individual distribution is generated, a logical comparison (not shown in the flowchart) made be made to determine whether the distribution is valid (e.g., whether the constraints are satisfied). If a distribution is not valid, further use of the particular distribution may be omitted. Alternatively, the constraints can be addressed during the assignment of weights to the processor bins by modification of the IPP algorithm bin assignment logic.

In step 207, a logical comparison is made to determine whether the generation distribution is perfect (e.g., each processor is assigned the same total weight in planned work). If so, the generated distribution is stored to make the distribution available for subsequent scheduling operations (step 211). Also, previously calculated non-perfect distributions can be erased upon the generation of a perfect distribution.

If not, the process flow proceeds to step 208 where another logical comparison is made to determine whether the variable N equals one. If not, the process flow proceeds to step 209 where N is decremented and the process flow returns to step 204. Accordingly, the number of weights associated with the default group is changed and the weight values are changed. By modifying the integer partition problem in this manner and re-solving the problem, accuracy of the distribution may be improved and the probability of obtaining an exact distribution is increased.

If N equals one during the logical comparison of step 208, the process flow proceeds to step 210. In step 210, the stored distributions are examined to identify the M-best distributions (i.e., the distributions that minimize the difference between the weights assigned to each processor). In step 211, the identified distributions are stored to make the distributions available for subsequent scheduling operations.

In some representative embodiments, the process flow of FIG. 2 is performed on a relatively infrequent basis in terms of scheduling operations. Specifically, the results of the process flow will not vary unless the number of available processors changes or the assignment of shares to the groups changes. Accordingly, the process flow of FIG. 2 does not impose significant overhead and does not reduce workload performance.

FIG. 4 depicts distribution 400 that may be produced according to the flowchart of FIG. 2 according to one representative embodiment. Suppose that a system supports eight jobs (A-G). The system includes three processors and, therefore, 300 shares are available (3*100). Also, suppose job A is assigned a share value of 80 and is associated with a two virtual-processor virtual machine. Also, suppose jobs B, C, and D are each assigned share values of 60. Jobs A-D are assigned to single job groups (I-IV). Jobs E-G are assigned to a default group (group V). The default group receives a share value of 40, i.e., the share amount not assigned to other groups (300—80—60—60—60). The share value of group I that includes job A is broken into two weights to support the two virtual processors. A constraint is also defined to prevent these weights from being assigned to the same physical processor.

The IPP solving process for these weights and the constraint may result in distribution 400 as shown in FIG. 4. The first weight of group I is assigned to processor 1 and the second weight of group I is assigned to processor 2. The weight of group II, the weight of group of III, and the weight of group IV are assigned to processors 1, 2, and 3 respectively. In this case, the share value of group V is not broken into multiple weights and the single weight of group V is assigned to processor V. The scheduling of the executables of groups A-G will then occur on the processors identified in distribution 400.

FIG. 3 depicts a flowchart for performing scheduling individual jobs on specific physical CPUs according to one representative embodiment. FIG. 3 is implemented using software code or instructions retrieved from a suitable computer readable medium. For example, a scheduling software routine of an operating system that is called in response to system interrupts may be used to implement the flowchart of FIG. 3.

In step 301, job scheduling parameters are updated according to the receipt of processor ticks by the jobs. Jobs receiving less than a group average during a time sampling interval have their parameters incremented. Jobs receiving less than a group average have their parameters decremented. Parameters values associated with jobs that are idle or have low demand may be allowed to decay to zero over time.

In step 302, the group error or errors are computed (if any). In step 303, a distribution is selected to correct for any cumulative group error. Specifically, if multiple distributions have been generated, because an exact distribution has not been identified, alternation between distributions may occur upon various iterations of the process flow. For example, if distribution A favors group 1 and distribution B favors group 2, alternation between the two distributions enables scheduling between jobs to occur in a more accurate manner. If an exact distribution was identified, the exact distribution is used.

In step 304, the jobs in each group are scheduled according to the selected distribution and using the respective job scheduling parameters. Specifically, for each group, the jobs of the group are ordered by their respective job scheduling parameters. The list of CPUs for the group as defined by the distribution are ordered by “desirability.” Specifically, CPUs having lower total scheduling weight possess greater desirability, because the processing capacity of such CPUs is divided into relatively larger segments or portions for the executables of different groups. If the total scheduling weight of multiple CPUs are equal, the historical usage of the CPUs can be used to determine the relative desirability. Specifically, if a CPU exhibits lower historical usage, it is more probable that some job will not use its scheduled portion of the processing capacity and such capacity can be used by another job.

Mapping groups of executables to processors using an IPP algorithm and monitoring the receipt of processing resources by executables enables each job within a respective group to experience the same amount of processor capacity. Accordingly, some representative embodiments provide a scheduling algorithm that is substantially more “fair” than other known multi-processor scheduling algorithms. Additionally, imperfect distributions and jobs with low demand only affect jobs for a limited number of intervals. Specifically, mapping individual jobs to specific processors using the job scheduling parameters prevents such issues from permanently skewing scheduling operations to the detriment of a subset of jobs. Imperfections between groups can be addressed using alternation between multiple distributions generated by the IPP algorithm. Additionally, by separating the group mapping from executable assignment, some representative embodiments impose relatively low overhead thereby omitting the diversion of processor resources from applications to scheduling operations.

What is claimed is:

1. A computer system, comprising:
a plurality of processors;
a plurality of groups of executables, wherein a respective share parameter is defined for each group that represents an amount of processor resources to support executables of said group;
a software routine that generates a plurality of weights using said share parameters and generates a distribution of said weights across said plurality of processors, wherein said distribution defines a subset of processors for each group and a proportion of each processor within said subset for scheduling executables of said group; and
a scheduling software routine for scheduling each executable of said plurality of groups on a specific processor of said plurality of processors during a scheduling interval according to said distribution.

2. The computer system of claim 1 wherein said software routine generates multiple distributions.

3. The computer system of claim 2 wherein said software routine generates multiple distributions by varying a number of weights produced from a share parameter assigned to at least one of said plurality of groups.

4. The computer system of claim 3 wherein said variable number of weights are generated from a share parameter that is assigned to a default group.

5. The computer system of claim 4 wherein said share parameter equals an amount of processor resources not assigned to other groups.

6. The computer system of claim 2 wherein said scheduling software routine alternates between said multiple distributions to compensate for scheduling differentials between said plurality of groups.

7. The computer system of claim 1 further comprising:
a software routine for maintaining scheduling parameters for executables of said plurality of groups, wherein each scheduling parameter is indicative of an amount of processor resources received by a respective executable relative to a group average.

8. The computer system of claim 7 wherein said scheduling software routine assigns a subset of executables of said plurality of groups, according to said scheduling parameters values, to one or several processors that provide said subset of executables additional opportunities to receive processor resources within an allocation period.

9. A method, comprising:
defining a plurality of share parameters that represent an amount of processor resources for scheduling executables of a plurality of groups;
generating a plurality of weights according to an integer partition problem (IPP) using said plurality of share parameters;
determining a distribution of said weights across a plurality of processors using an IPP algorithm; and
scheduling executables of groups on said plurality of processors using said distribution.

10. The method of claim 9 further comprising:
maintaining scheduling parameters for executables of said plurality of groups, wherein each scheduling parameter is indicative of an amount of processor resources received by a respective executable relative to a group average.

11. The method of claim 10 wherein said scheduling comprises:
selecting executables according to said scheduling parameters values for one or several processors that provide said selected executables additional opportunities to receive processor resources within a scheduling interval.

12. The method of claim 9 wherein said generating comprises:
generating multiple weights from a share parameter when said share parameters is associated with a group having at least one multi-threaded executable.

13. The method of claim 12 further comprising:
defining a constraint for said IPP to schedule threads of said multi-threaded executable on different processors.

14. The method of claim 9 wherein said generating and determining are performed multiple times to generate multiple distributions, wherein one of said share parameters is divided into a different number of weights upon each repetition.

15. The method of claim 14 wherein said scheduling alternates between multiple distributions to balance scheduling imperfections between groups.

16. The method of claim 14 wherein said share parameter is associated with a default group.

17. The method of claim 16 wherein said share parameter represents an amount of resources left over after assignment of share parameters to other groups.

18. The method of claim 9 wherein said executables are virtual processors that support respective virtual machines.

19. A computer system, comprising:
a plurality of resource devices;
a plurality of groups of executables, wherein a respective share parameter is defined for each group that represents an amount of access to said plurality of resource devices to support executables of said group;
a software routine that generates a plurality of weights using said share parameters and generates a distribution of said weights across said plurality of resource devices, wherein said distribution defines a subset of resource devices for each group and a proportion of each resource device within said subset for scheduling executables of said group; and
a scheduling software routine for scheduling each executable of said plurality of groups on a specific resource device of said plurality of resource devices according to said distribution.

20. The computer system of claim 19 wherein said plurality of resource devices are selected from the list consisting of: processors, networking cards, disk input/output (IO) channels, and cryptographic devices.

21. The computer system of claim 19 further comprising:
a software routine for maintaining scheduling parameters for executables of said plurality of groups, wherein each scheduling parameter is indicative of an amount of resource device access received by a respective executable relative to a group average.

22. The computer system of claim 21 wherein said scheduling software routine assigns a subset of executables of said plurality of groups, according to said scheduling parameters values, to one or several resource devices that provide said subset of executables additional opportunities to receive resource device access within an allocation period.

23. A computer system, comprising:
means for generating a distribution of weights across a plurality of resource devices of said computer system using an integer partition problem (IPP) algorithm, wherein said weights are generated from a plurality of share parameters that each represent an amount of access to said plurality of resource devices to be provided to a respective group of executables, wherein said distribution defines a subset of resource devices for each group and a proportion of each resource device within said subset for scheduling executables of said group; and
means for scheduling each executable of said groups on a resource device according to said distribution.

24. The computer system of claim 23 further comprising:
means for maintaining scheduling parameters for executables of said groups, wherein each scheduling parameter is indicative of an amount of resource device access received by a respective executable relative to a group average.

25. The computer system of claim 24 where said means for scheduling assigns a subset of executables of said groups, according to said scheduling parameters values, to one or several resource devices that provide said subset of executables additional opportunities to receive resource device access within an allocation period.
